(19) United States
(12) Patent Application Publication
(10) Pub. No.: US 2014/0137950 A1
(43) Pub. Date: May 22, 2014

(54) INKJET PRINTERS

(71) Applicant: Stephen Watts, Gretton (GB)

(72) Inventor: Stephen Watts, Gretton (GB)

(73) Assignee: DOMINO PRINTING SCIENCES PLC, Cambridge (GB)

(21) Appl. No.: 13/885,208

(22) PCT Filed: Nov. 21, 2011
(86) PCT No.: PCT/GB11/52276

§ 371 Date: Jul. 30, 2013

(30) Foreign Application Priority Data
Nov. 19, 2010 (GB) 1019687.1

(51) Int. Cl. B41J 2/175

(52) U.S. Cl. CPC B41J 2/17596
USPC 137/315.01; 29/890.1

(57) ABSTRACT

The invention provides an adaptor for mounting a pump directly to the ink circulation system of an inkjet printer. By incorporating an adaptor and providing a selection of adaptors, a variety of pumps can be fitted to the ink circulation system without the need for pipes and pipe connectors.

### FIELD OF THE INVENTION

This invention relates to an inkjet printer and in particular, though not necessarily solely, to a method of and/or means for mounting a pump in a continuous inkjet (CIJ) printer.

### BACKGROUND TO THE INVENTION

In an inkjet printing system ink is typically circulated around a fluidic circuit by a pump. Within the circuit there are control valves to control various flows so to perform various functions. One of those functions is to deliver a small proportion of the ink flow to the printing head for printing.

The fluidic circuit typically has sensors to measure and/or control the pressure and the temperature of the ink.

The pump contains moving parts and typically has to be suitable for pumping a variety of inks. Inkjet inks are such that in some cases the pump is subjected to a levels of wear and corrosion and it is therefore expected that the pump is a replaceable part that may need to be changed throughout the life of the printer.

It is desirable from both a cost and supply perspective to be able to use pumps that are not bespoke designs for a particular printer, however pumps from different suppliers typically have different porting arrangements and are connected to the printer's ink system via flexible tubing and appropriate connection end fittings. The tubing and associated end fittings are potential sources of leaks.

Replacement of a failing or failed pump is typically a service action and is undertaken by skilled personnel, e.g. a service technician or suitably trained maintenance operative, and requires the printer to be taken out of service and off line for 30 to 60 minutes.

It is an object of this invention to provide an inkjet printer, and/or one or more components therefor, which will go at least some way in addressing aforementioned problems; or which will at least provide a novel and useful choice.

### SUMMARY OF THE INVENTION

Accordingly in a first aspect, the invention provides a method of mounting a pump to an ink circulation system of an inkjet printer, said method including engaging said pump within an adaptor such that ports included in said pump communicate directly with corresponding ports in said adaptor; and engaging said adaptor directly with said ink circulation system.

Preferably said method further includes selecting an adaptor tailored to the geometric features of said pump.

In a second aspect the invention provides an adaptor for mounting a pump to an ink circulation system of an inkjet printer, said adaptor having one or more ports directly communicable with ports on said pump, said adaptor being directly mountable to said ink circulation system.

Preferably said adaptor comprises a body in which said pump is received, ports within said body communicating directly with ports in said pump.

Preferably said adaptor further includes one or more retainers operable to retain said pump within said adaptor.

In a third aspect the invention provides a selection of adaptors as set forth above, each adaptor in said selection having a substantially common interface which, in use, can be engaged with an ink circulation system of an inkjet printer, but different port geometries to suit the port geometries of different pumps.

Many variations in the way the present invention can be performed will present themselves to those skilled in the art. The description which follows is intended as an illustration only of one means of performing the invention and the lack of description of variants or equivalents should not be regarded as limiting. Wherever possible, a description of a specific element should be deemed to include any and all equivalents thereof whether in existence now or in the future. Any limitation in the scope of the invention should be established by reference to the appended claims alone.

### BRIEF DESCRIPTION OF THE DRAWINGS

The various aspects of the invention, in one preferred form, will now be described with reference to the accompanying drawings in which:

FIG. 1: shows an isometric view of a pump mounted on an ink circulation system by way of an adaptor according to the invention;

FIG. 2: shows a frontal isometric view of an adaptor according to the invention;

FIG. 3: shows a rear isometric view of the adaptor shown in FIG. 2; and

FIG. 4: shows a schematic cross-section of a adaptor according to the invention retaining a pump on an ink circulation system

### DETAILED DESCRIPTION OF WORKING EMBODIMENT

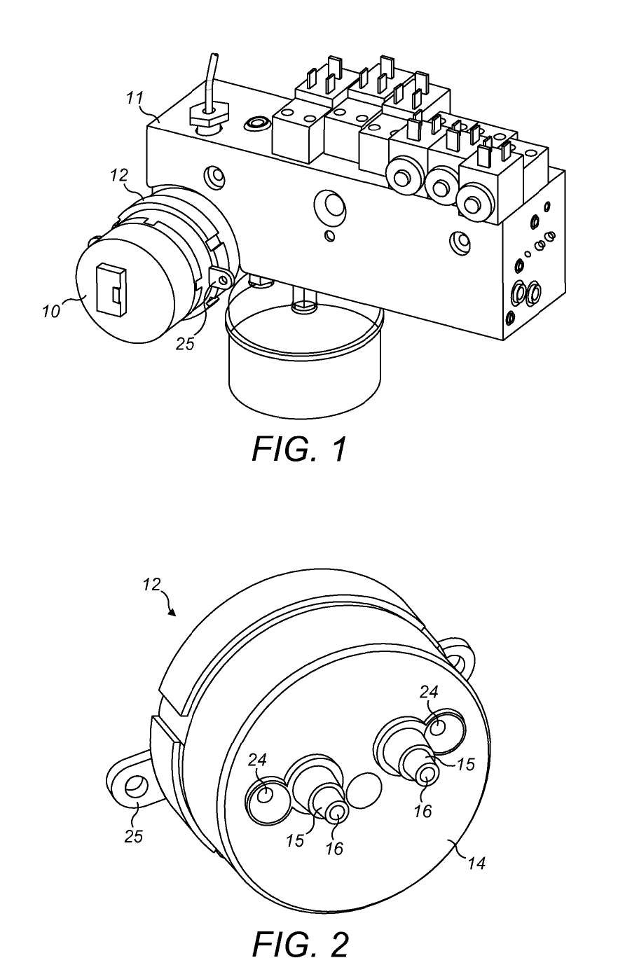

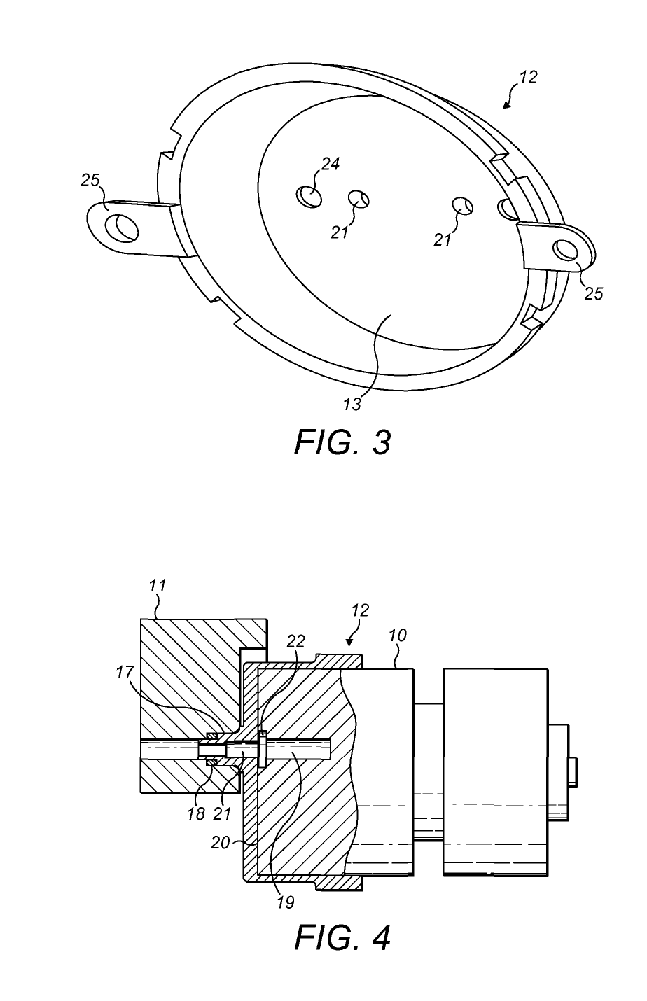

Referring to FIG. 1, the invention provides a method of mounting a pump 10 to an ink circulation system 11 of an inkjet printer. To enable the use of a variety of pumps and, in particular, avoid having to commit to a bespoke pump, the invention comprises using an adaptor 12 to mount the pump 10 to the circulation system 11. By providing a variety of adaptors for different pump geometries, a number of alternative, readily available pumps may be used.

The adaptor 12 has a pump interface 13 and an ink system interface 14. As shown, the ink system interface comprises a pair of spigots 15, having fluid ports 16, which engage in sockets 17 in the ink circulation system. It will be appreciated that, for any particular model of printer, the ink system interface 14 will always be the same. An O-ring 18 may be provided about the outer surface of each spigot 15 to provide a seal between the spigot and its respective socket 17.

In the case of the particular embodiment herein described, the adaptor broadly comprises a hollow body, the interior surfaces of which define the pump interface 13. The particular form of pump 10 is circular in cross-section and has ink ports 19 extending from an end face 20 thereof. Thus ports 21 on the inner surface of the adaptor, which are in fluid communication with the ports 16 on the spigots 15, are sized and positioned to align with the ports 19 on the pump. To minimise the possibility of leakage, O-ring seals 22 may be positioned between the ports 19 and 21. To retain the pump within the adaptor and apply compression to the O-rings 22, machine screws (not shown) may be passed through holes 24 in the adaptor and engaged with threaded holes in the end face 20 of the pump.

The pump and adaptor assembly may be held in engagement with the ink circulation system by clips (not shown) which attach between the ink system and brackets 25 formed in the adaptor 12.

It is envisaged that a selection of adaptors will be provided which are configured to mount a variety of different pumps. Thus, in the event that it is necessary to change the pump, the replacement pump can be selected from the range for which an adaptor is available. This will assist in keeping costs down and will avoid production delays which could occur if a replacement for one particular pump type was not readily available.

1. A method of mounting a pump to an ink circulation system of an inkjet printer, said method including engaging said pump within an adaptor such that ports included in said pump communicate directly with corresponding ports in said adaptor; and engaging said adaptor directly with said ink circulation system.

2. A method as claimed in claim 1 further including selecting an adaptor tailored to the geometric features of said pump.

3. An adaptor for mounting a pump to an ink circulation system of an inkjet printer, said adaptor having one or more ports directly communicable with ports on said pump, said adaptor being directly mountable to said ink circulation system.

4. An adaptor as claimed in claim 3 comprising a body in which said pump is received, ports within said body communicating directly with ports in said pump.

5. An adaptor as claimed in claim 3 further including one or more retainers operable to retain said pump within said adaptor.

6. A selection of adaptors as claimed in claim 3, each adaptor in said selection having a substantially common interface which, in use, can be engaged with an ink circulation system of an inkjet printer, but different port geometries to suit the port geometries of different pumps.
